(19) United States
(12) Patent Application Publication
(10) Pub. No.: US 2003/0106065 A1
(43) Pub. Date: Jun. 5, 2003

(54) Information distribution system, program guide server, and distribution data selection chart server

(75) Inventors: Junichi Sakai, Tokyo (JP); Mamoru Nobue, Kawachi-gun (JP); Tomio Ogawa, Tokyo (JP); Masayuki Imoto, Tokyo (JP); Kazuyoshi Inoue, Tokyo (JP); Nobuaki Tasaki, Matsudo (JP); Mariko Goto, Tokyo (JP)

Correspondence Address: GREENBLUM & BERNSTEIN, P.L.C., 1950 ROLAND CLARKE PLACE, RESTON, VA, 20191, US

(73) Assignee: Matsushita Graphic communication Systems, Inc., Tokyo (JP)

(21) Appl. No.: 10/292,529

(22) Filed: Nov. 13, 2002

(30) Foreign Application Priority Data
Nov. 30, 2001 (JP) 2001-367387
Mar. 15, 2002 (JP) 2002-072158

(51) Int. Cl. H04N 7/173

(52) U.S. Cl. 725/91

(57) ABSTRACT

An information distribution system is provided where broadcasting contents are distributed to an IP network using a multicast address for each set of contents, and a home gateway at home connected to the IP network receives desired contents. A program guide server that retains multicast addresses used for each content distribution is also provided in the system, so that a multicast address of a desired contents can be obtained by accessing the program guide server from a program selection terminal via the IP network, and the home gateway can receive the desired contents based on the multicast address.

### BACKGROUND OF THE INVENTION

1. Field of the Invention

The present invention relates to an information distribution system, program guide server, and distribution data selection chart server that can display various contents, including broadcasting contents from a data center/broadcast station, on a viewer terminal via an IP network such as the Internet.

2. Description of Related Art

In recent years of a rapid spread of broadband uses in the Internet environment, such as XDSL and FTTH, a new generation of Internet services has began in which broadband services that provide rich contents (e.g., motion pictures) via Internet are utilized.

Moreover, an application that uses the Internet for broadcasting has been tested, which is performed by a method “Multicast Backbone (MBONE)”. While a communication normally performed on the Internet uses a uni-cast distribution method that communicates with a specific partner, the MBONE uses a multicast distribution method that broadcasts to a group of a specific range, introducing a concept of multi address. Such a multicast distribution has an advantage of lightning a network load, compared to a uni-cast distribution, which distributes data to all viewer terminals with one-to-one communication. This is because the multicast distribution is configured with a system where data is copied by multipoint routers on paths between a server and various viewer terminals so that data is forwarded to individual routers in the lower streams.

In order to provide a multicast distribution to a user at a viewer terminal, a multicast address corresponding to desired broadcasting contents needs to be obtained and setup in a router.

However, when a plurality of program data contents (i.e., broadcasting contents), having a different multicast address for each program, are used, there is no agreed system in which a user obtains a multicast address corresponding to a desired program.

### SUMMARY OF THE INVENTION

The present invention addresses the above-described problem. The purpose of the present invention is to provide an information distribution system, program guide server, and distribution data selection chart server with which user can easily obtain a multicast address for distributing the program using the multicast method and automatically receive the program distribution, just by selecting a desired program.

This invention provides a program guide server that retains a program guide displaying various contents distributed via IP network in a program guide format, and multicast addresses used for distributing individual contents. In response to a request from an accessing terminal via IP network, the program guide server transmits the program guide including the multicast address to the requester terminal. Contents (distribution data) are not limited to TV broadcasting programs (including movie images, product introduction images, etc.), but can include unedited video images of a TV camera and other contents.

According to the present invention, a program guide including multicast address of each set of contents can be transmitted to a terminal, in response to a request from the terminal. Therefore, it is possible for the terminal to obtain the multicast address from the program guide and use the same for receiving a desired set of contents.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a system configuration of an entire video image distribution system according to an embodiment of the present invention;

FIG. 2 is a sequence chart according to the embodiment;

FIG. 3 is a flowchart illustrating a program guide server, program selection terminal, and home gateway;

FIG. 4 illustrates an exemplary display of an EPG homepage screen provided by the program guide server;

FIG. 5 illustrates an exemplary display of the EPG provided by the program guide server;

FIG. 6 illustrates a relationship between an individual program displayed on the EPG and a source code embedded in the program display location;

FIG. 7 is a schematic illustration of an EPG generation process at the program guide server;

FIG. 8 is a functional block diagram of the home gateway;

FIG. 9 is a flowchart illustrating an IP reception/forwarding process at the home gateway;

FIG. 10(a) illustrates a configuration of an IP packet data received by the home gateway;

FIG. 10(b) illustrates a configuration of an IEEE1394 packet data forwarded by the home gateway;

FIG. 11 is a flowchart related to IEEE1394 forwarding at the home gateway;

FIG. 12 illustrates a system configuration of the entire video image distribution system according to the second embodiment of the present invention;

FIG. 13 is a sequence chart according to the second embodiment of the present invention;

FIG. 14 illustrates a display example of a homepage screen of a distribution data selection chart server according to the second embodiment of the present invention; and

FIG. 15 illustrates a display example of an EPG provided by the distribution data selection chart server according to the second embodiment of the present invention.

### DETAILED DESCRIPTION OF PREFERRED EMBODIMENTS

The embodiment of the video image distribution system according to the present invention is explained in the following, in reference to the above -described drawings.

First Embodiment

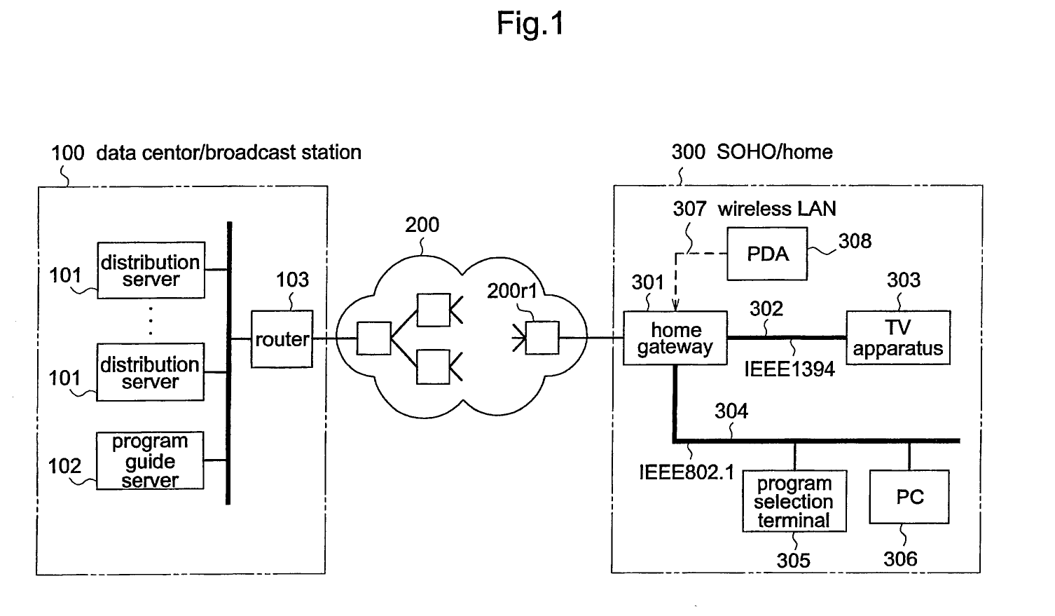

FIG. 1 illustrates a system configuration of an entire video image distribution system according to the embodiment of the present invention. FIG. 1 shows a broadcasting system in which data center/broadcast station 100 broadcasts contents (hereafter referred to as “program”) to a plurality of SOHO (Small Office, Home Office)/home 300 via Internet 200. The sender of the broadcasting program is typically a broadcast station, however, it can be a data distribution center other than a broadcast station. In this embodiment, the sender is referred to as data center/broadcast station 100. The location for setting the TV apparatus to receive and display broadcasting programs can be at a home, business office, and on a street, similar to existing ground wave TV or satellite broadcasting systems. In this embodiment, it is referred to SOHO/home 300.

Data center/broadcast station 100 has distribution server 101 that distributes program video images for each program, and program guide server 102 that generates and transmits electronic program guide (hereafter referred to as “EPG”). Data center/broadcast station 100 is connected to Internet 200 via router 103. Distribution server 101 uses a multicast address assigned to its distributing program and multicasts the program video images on Internet 200. Program guide server 102 can operate as an HTTP server and transmits an EPG in response, which includes a multicast address for each program generated according to the requester, after receiving a request from program selection terminal 305.

SOHO/home 300 has home gateway 301, which is connected to Internet 200 outside of home, while being connected to the home network at home. Home gateway 301 can exchange data with TV apparatus 303 via IEEE 1394 network 302 that operates in accordance with the IEEE1394 standard. Home gateway 301 can also exchange data and is connected with program selection terminal 305 and personal computer 306 via IEEE802.1 network 304 that operates in accordance with the IEEE802.1 standard. Further, home gateway 301 can exchange data with PDA 308 via wireless LAN 307. However, the protocol for data exchange in the home network is not limited to the above. Program selection terminal 305 obtains an EPG by accessing the program guide server 102 using an installed browser function, informs home gateway 301 about the multicast address of the selected program, when the user selects a desired program, and requests home gateway 301 for a setting that is capable of receiving the program. While PDA 308 has the same function as program selection terminal 305, PDA 308 has an interface with home gateway 301 with a wireless connection. It is not necessary to have both program selection terminal 305 and PDA 308 at the same time, thus, the following illustration only uses program selection terminal 305.

Hereafter, an operation of the video image distribution system according to the embodiment with the above-described configuration is illustrated.

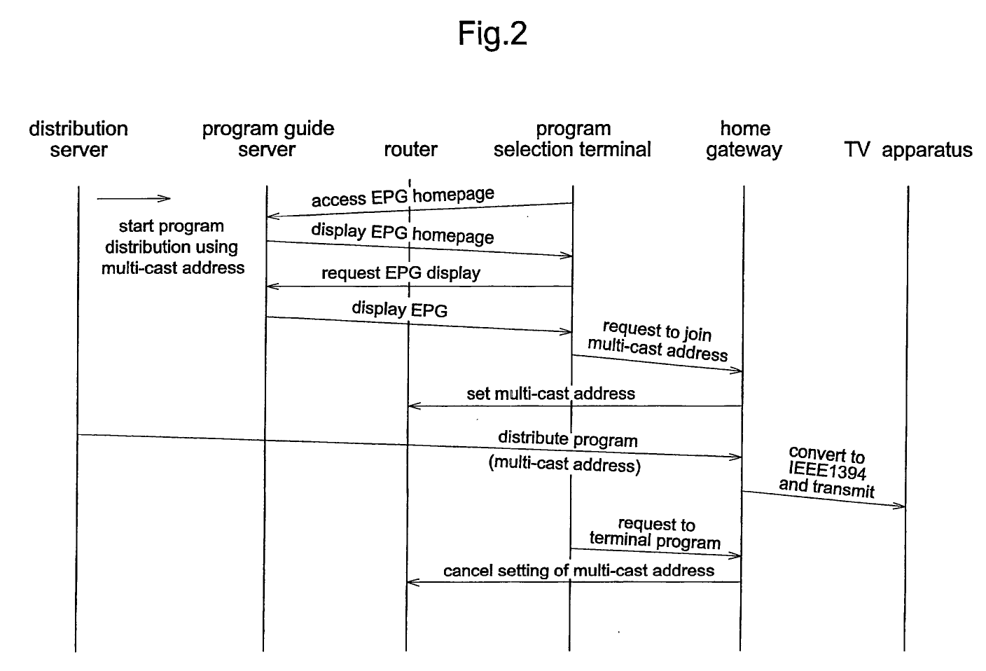

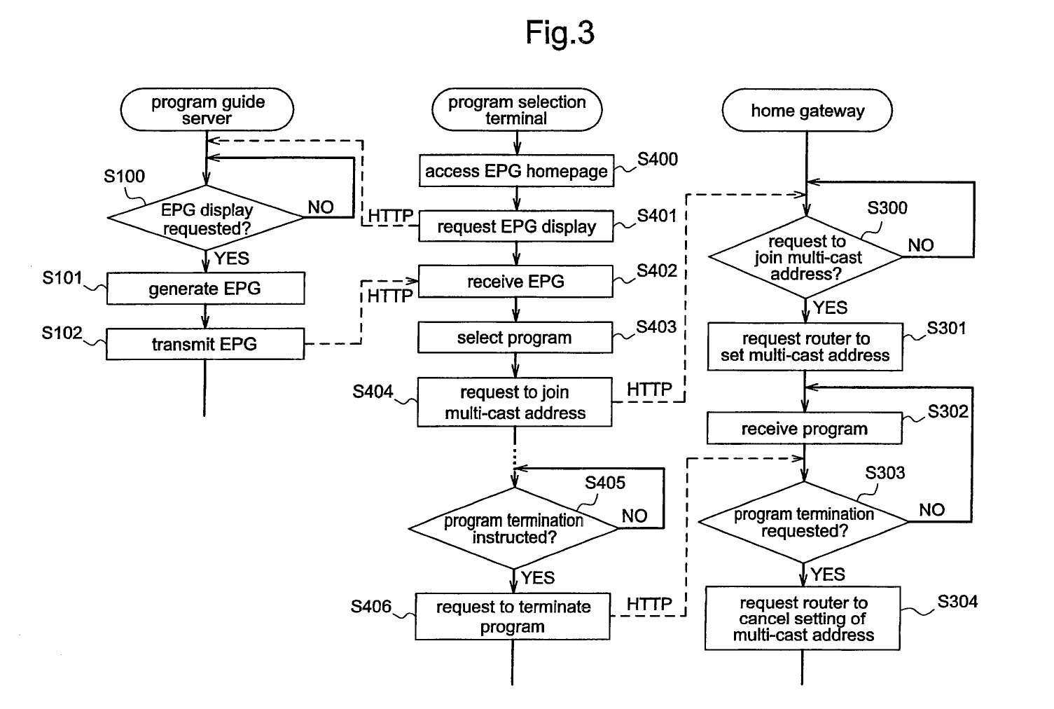

FIG. 2 is a sequence chart illustrating an operation of setting/canceling a multicast address of a desired program according to the embodiment. FIG. 3 is a flowchart illustrating a process in each apparatus in relation to the sequence chart in FIG. 2.

When a user wishes to receive a desired program distribution at SOHO/home 300, the user operates program selection terminal 305 and accesses an EPG homepage provided by program guide server 102 (step S400). For example, the user accesses the EPG homepage by inputting an URL of the EPG homepage, which is provided by program guide server 102, using the browser function of program selection terminal 305. The URL of the EPG homepage can be preprogrammed in program selection terminal 305, having a button that accesses the EPG homepage in the browser's start-up screen, so that, when the button is clicked, the browser can recognizes the preprogrammed URL and automatically requests the EPG homepage.

The browser operating on the program selection terminal 305 uses “cookie” information when initially accessing program guide server 102, in order to transmit the IP address of home gateway 301. In this embodiment, the IP address of the home gateway 301 set in SOHO/home 300 is preprogrammed in program selection terminal 305.

However, the system of informing the program guide server 102 about the IP address of home gateway 301 is not limited to the method of using a “cookie”, as long as the program guide server 102 can recognize the IP address with any method, until program guide server 102 generates an EPG that matches with program selection terminal 305. The same applies to requesting a program-at-a-glance using later-described keyword/genre searches.

Program guide server 102 operates as an HTTP server and can detect a request coming from the outside. When it is determined that the request received from the outside is an access request to an EPG homepage, program guide server 102 allows the requester to display the EPG homepage screen using the HTTP.

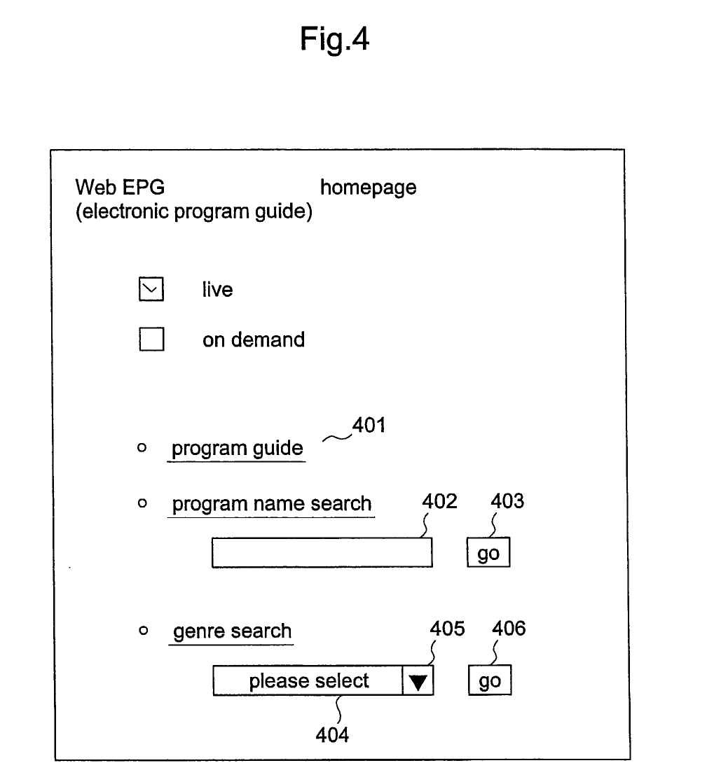

FIG. 4 illustrates an exemplary display of the EPG homepage screen. When “program guide” 401 is selected, it is programmed to transmit an EPG display request to program guide server 102. A program name can be searched by a keyword; therefore when a desired keyword is input in searching keyword input box 402 and select button 403 is selected, program-at-a-glance (HTML file) from the search result based on the input keyword is requested from program guide server 102. Genre search is also available; therefore, when a searching genre is input in searching genre input box 404 and select button 406 is selected, program-at-a-glance (HTML file) form the search result based on the genre is requested from program guide server 102. Searchable genre is prearranged, and the desired genre can be input in the searching genre input box 404 by using scroll button 405.

When a user selects “program guide” 401 on the EPG homepage screen, which is displayed on program selection terminal 305, program selection terminal 305 transmits an EPG display request to program guide server 102 (step S401).

When program guide server 102 determines that the EPG display request is received (step S100), an EPG that matches with program selection terminal 305 (requester) is generated in HTML (step S101).

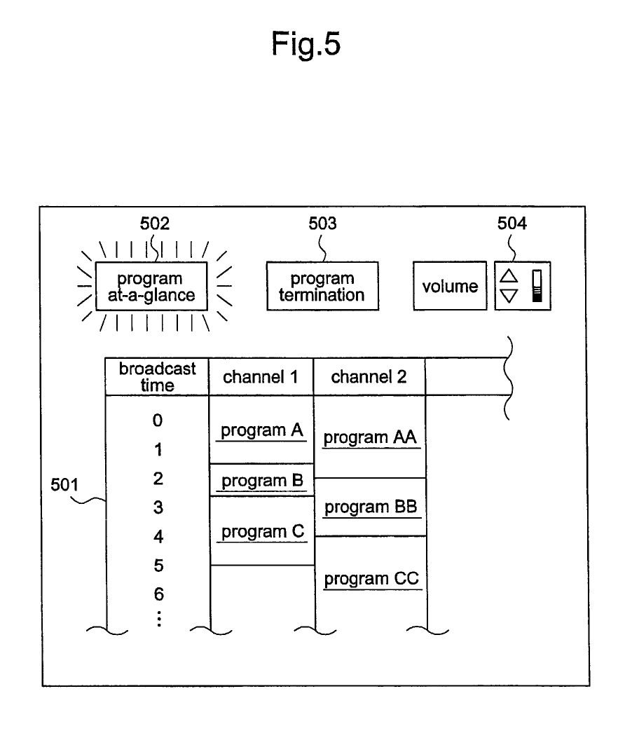

The EPG generated at step S101 is illustrated in detail below. FIG. 5 is an example of the EPG display. Table 501 is displayed that associates broadcasting time periods with program names (A, B, C, AA, BB, CC, etc.) for each channel. In addition, program-at-a-glance button 502 that displays Table 501, program termination button 503 that instructs a termination of a selected program, and a volume button 504 that adjusts the volume of selected program are provided on top of table 501.

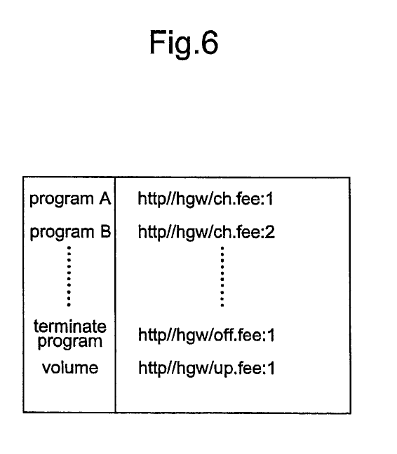

As shown in FIG. 6, a source code (HTML source) of a separate page is embedded in each program (A, B, C, . . . ) listed in table 501. For example, a source code “http//hgw/ch.fee:1” is embedded in “program A”. “hgw” is an IP address of home gateway 301 inserted in the script of the EPG display request, which is generated at step S401. “ch” is a command that is recognized and executed by home gateway 301, stating “set the character string (fee:1) after the command (ch) as a multicast address”. Accordingly, when the multicast address is set in router 200r1, it is possible to receive the distribution of program A. “fee:1” is a multicast address for distributing “program A”. Such a source code is set in every program.

Therefore program selection terminal 305 can obtain a multicast address that distributes each program, and receive the program distribution, using the multicast address. It is because EGP in which the multicast address is written, is generated to each program displayed on table 501, and is transmitted from program guide server 102 to program selection terminal 305.

Moreover, a source code “http//hgw/off/fee:1” is embedded in program termination button 503. “off” is a command that is recognized and executed by home gateway 301, stating “cancel the multicast address setting made from character string (fee:1) after the command (off)”. Therefore, when the multicast address setting is canceled from router 200r1, it is possible to stop the distribution of program A. When program termination button 503 is selected, the multicast address of the currently selected program is set to a source cord for program termination button 503 as a multicast address to cancel the setting. Or when the setting of the multicast address is requested after a program is selected, the multicast address can be automatically set as a source cord for program termination button 503.

A source code “http//hgw/up.fee:1” is embedded in an up mark of volume button 504. “up” is a command that is recognized and executed by home gateway 301, stating “raise the volume of video images distributed by a multicast address made from character string (fee:1) after the command (up)”. Source code “http//hgw/down.fee:1” states lowering of the volume, which is opposite from the up mark of volume button 504.

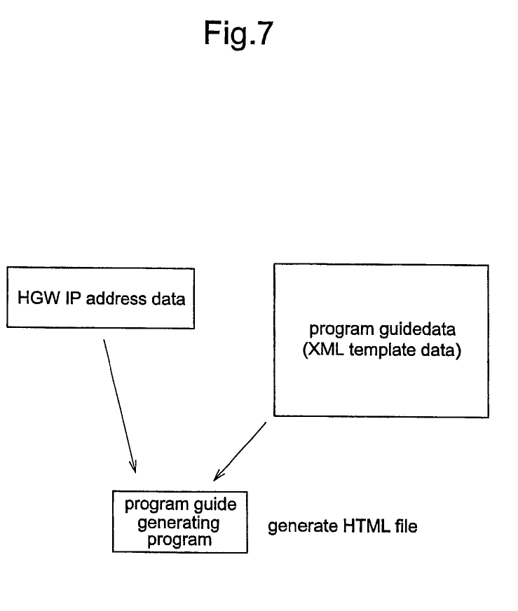

FIG. 7 is a schematic illustration of combining the IP address of the home gateway and program guide data. The EPG of FIG. 5 is displayed by program guide generation program (HTML file).

Program-at-a-glance extracted from keyword/genre search also generates an EPG.

Accordingly, an EPG that includes multicast addresses of each program is generated and transmitted to program selection terminal 305 (requester) (step S102). When an EPG is received form program guide server 102 (step S402), program selection terminal 305 displays the EPG shown in FIG. 5. The user then selects and clicks the desired program that is being distributed from table 501 (step S403).

The following illustration is provided as “program A” is selected within table 501. Based on the source code “http//hgw/ch.fee:1” embedded in association with “program A”, program selection terminal 305 accesses home gateway 301, which is addressed with “hgw” with the HTTP, and delivers multicast address “fee:1” (which distributes selected program A) to the HTTP server of home gateway 301 along with the command “ch” (step S404). By delivering the command “ch” and multicast address “fee:1” to home gateway 301, a participation in multicast address “fee:1” is requested.

The HTTP server of home gateway 301 analyzes data transmitted as HTTP from outside. When the command “ch” is detected, the server recognizes that it is requesting to participate in the multicast address (step S300). Home gateway 301 executes the command “ch”, using a predetermined protocol (e.g., IGMP) toward upper layer router 200r1, to request a setup of the multicast address (fee:1). Router 200r1 exchanges multicast address information with surrounding routers (including the upper layer router), so that data that sets the multicast address (fee:1) will be forwarded to router200r1.

As a result, distribution server 101 setups the multicast address (fee:1) assigned to the broadcasting program (program A) and distributes the program data to Internet 200. The program data is then distributed to home gateway 301 via router 200r1, so that “program A” is received (step S302). The process in which home gateway 301 receives the program data and displays the same on TV apparatus 303 is later described.

In order to terminate the receiving program with the multicast setting, the user operates program selection terminal 305 and cancels the multicast address. The user clicks program termination button 503 of the EPG displayed on program selection terminal 305, shown in FIG. 5. In this embodiment, the screen that is used to select program A at step S403 is kept to be displayed as the initial screen when the browser function is initiated. When it is detected that program termination button 503 is clicked, program selection terminal 305 recognizes an instruction for terminating the program (step S405). Then, according to the source code “http//hgw/off.fee:1” embedded in association with program termination button 503, program termination request is generated (step S406). In particular, program selection terminal 305 transmits the command “off” and target multicast address “fee:1” to the HTTP server of home gateway 301.

When the HTTP server of home gateway 301 receives the program termination request from program selection terminal 305 (step S303), the HTTP server executes command “off” and cancels the multicast address setting (step S304). Particularly, the HTTP server executes the command “off”, using a predetermined protocol (e.g., IGMP) toward the upper layer router 200r1, to request the cancellation of the multicast address (fee:1) setting (step S304). Upper layer router 200r1 exchanges the table, in which the multicast address (fee:1) setting is canceled, with surrounding routers. Accordingly, the program data (program A) of the multicast address (fee:1) will no longer be forwarded to home gateway 301 from upper layer router 200r1, which terminates the program distribution.

Accordingly, by requesting an EPG display from program selection terminal 305 to program guide 102, it is possible to retrieve the EPG, which describes the multicast address for distributing each program, into program selection terminal 305. Also, by selecting a desired program using the EPG, it is possible to set the program distributing multicast address in router 200r1 and receive the program distribution. In order to stop the program distribution selected by the EPG, it is possible to cancel the multicast address of the program set in router 200r1, by clicking the program termination button 503 of the EPG. Accordingly, it is possible to simplify the process of obtaining/setting/canceling of multicast address relating to a program.

The following illustrates a process in relation to displaying programs at home gateway 301.

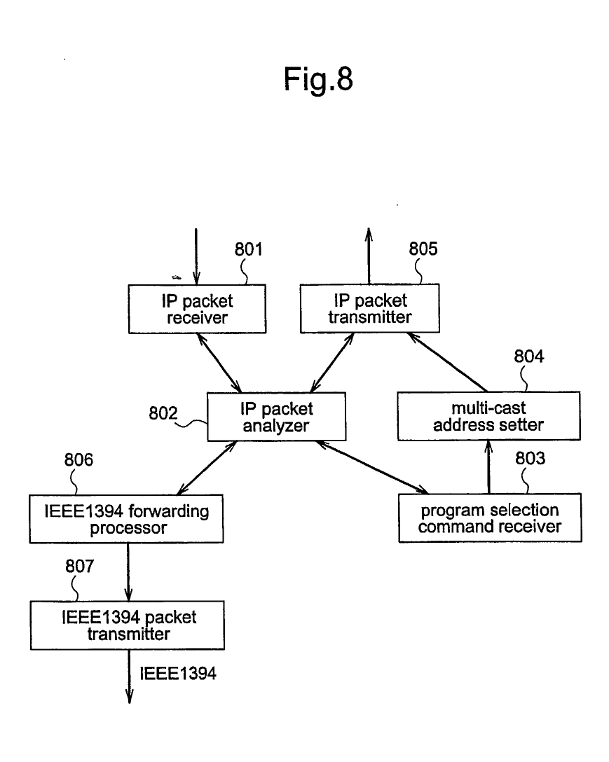

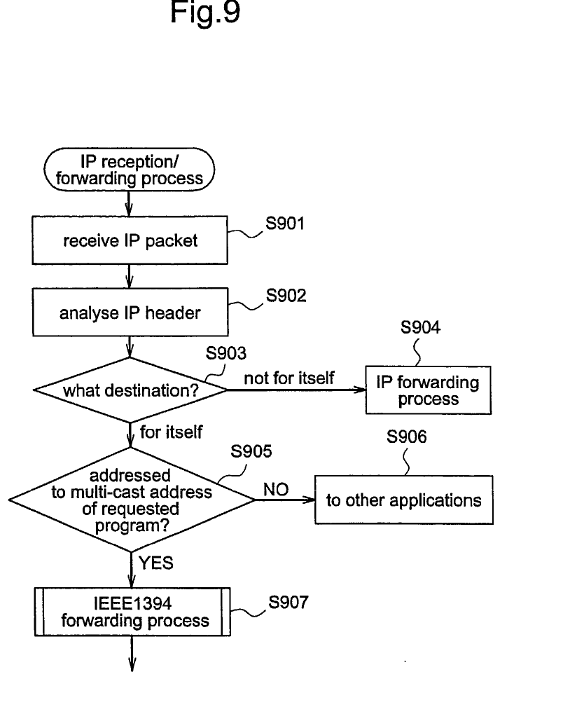

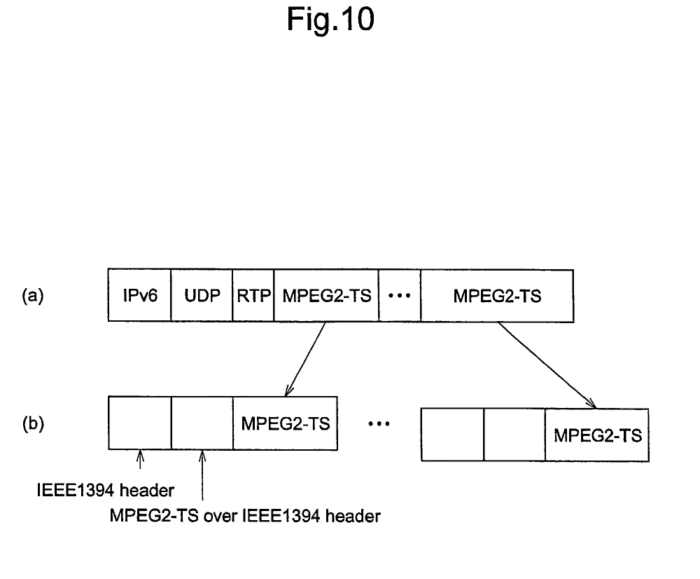

FIG. 8 is a functional block diagram in relation to an IP packet process and IEEE1394 forwarding process at home gateway 301. FIG. 9 is a flowchart illustrating a case where home gateway 301 receives an IP packet. When IP packet receiver 801 receives an IP packet from Internet 200 (or IEEE802.1 network) (step S901), IP packet analyzer 802 analyzes an IP header of the IP packet (step S902). As shown in FIG. 10, the IP header includes an IP address, UDP, and RTP. IP packet analyzer 802 checks the destination of the IP address to determine whether the IP address is intended to itself (step S903).

For example, if the IP address of program selection terminal 305 is intended destination address, the received IP packet is output to program selection terminal 305 via IEEE802.1 network. If the IP address is intended to itself, as explained later, the IP address is output to itself (home gateway 301).

When the destination address is home gateway 301 itself (hgw), or a participating multicast address, IP packet analyzer 802 retrieves the IP packet (step S905).

When the destination address is home gateway 301 itself (hgw), IP packet analyzer 802 delivers to a corresponding application from the port number set in the UDP (step S906). For example, when the IP packet relates to the program selection command that sets a multicast address, program selection command receiver 803 detects a command “ch” that relates to the program selection. Then, multicast address setter 804 executes command “ch”, generates data requesting a participation in the multicast address toward router 200r1, and transmits the data converted in to an IP packet from IP packet transmitter 805.

When the multicast address is already set, program data is distributed by making the multicast address as a destination address. When the destination address is a participating multicast address, IP packet analyzer 802 delivers the packet data by deleting its IP address and UDP from the IP header, to IEEE1394 forwarding processor 806.

As shown in FIGS. 10(a) and (b), IEEE1394 forwarding processor 806 converts the packet data that configures the program into a format that matches with the IEEE1394, and forwards the data to TV apparatus 303 (step S907).

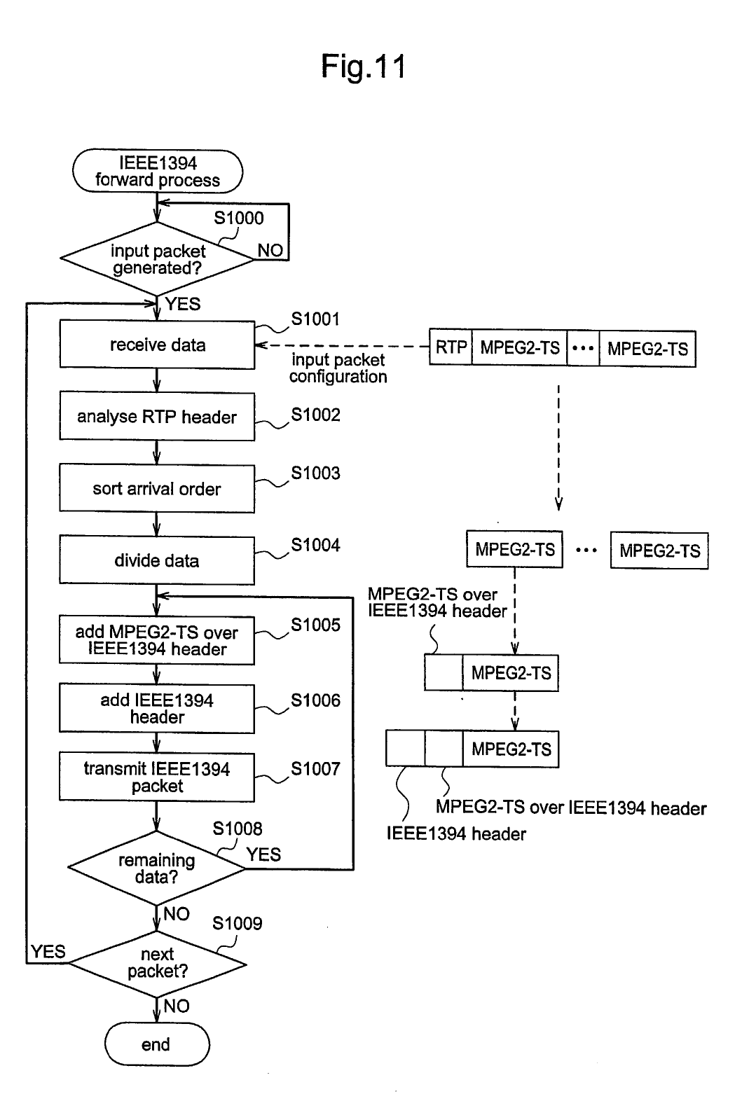

FIG. 11 is a flowchart illustrating IEEE1394 forwarding processor 806. When an input packet is generated (step S1000), the input packet is retrieved (step S1001), and the RTP that is attached to the packet header is analyzed (step S1002). Since the RTP has a packet order number that configures the currently distributed program, the packet arrival order is sorted based on the order number (step S1003). Data unit of a packet (MPEG2-TS) is divided at a predetermined size (step S1004), MPEG2-TS over IEEE1394 header is added to the divided data of each program (MPEG2-TS) (step S1005), and IEEE1394 header is further added to the same (step S1006). Accordingly, generated IEEE1394 packet is transmitted to IEEE1394 network 302 (step S1007). Then, it is checked whether there is remaining divided program data (MPEG2-TS) (step S1008). When there is no such data, it is checked whether there is a next packet (step S1009). When there is no next packet, the process is terminated. In addition, TV apparatus 303 has an IEEE1394 interface. Thus, a packet retrieved from network 302 is assembled, and MPEG2-TS is decoded and converted into an NTSC signal by a decoder, in order to display the data on a screen and output voice data at the same time.

As described above, when home gateway 301 receives an IP packet distributed using a multicast address, the IP packet is converted into an IEEE1394 packet and transmitted to IEEE1394 network 302, so that the screen of TV apparatus 303 can display the program.

The above illustration uses a case where broadcasting contents are distributed. However, it is possible to similarly distribute contents other than broadcasting contents, using multicast method.

Additionally, in the above described embodiment, both home gateway 301 and TV apparatus 303 use the IEEE1394 interface. However, it is possible to have a setting where home gateway 301 plays video image signals from the IP packet, converts the signals into NTSC signals, and outputs the same to an NTSC terminal of TV apparatus 303.

In the above-described embodiment, a desired program is viewed on TV apparatus 303; however, it can be viewed on program selection terminal 305. Further, program selection terminal 305 can be included in TV apparatus 303 in its configuration.

Second Embodiment

The second embodiment of the present invention is illustrated hereafter. For a conventional live sports program, a plurality of TV cameras are setup in a stadium, and one program is created by editing video images from the plurality of TV cameras in the editing room. In this embodiment, each video image captured by a TV camera is broadcasted in the multicast method, as each individual distribution data set (program).

It is noted that this invention is not limited to live sports programs, but can be applied to other sports programs and non-sports events provided that video images are distributed through a plurality of setup TV cameras.

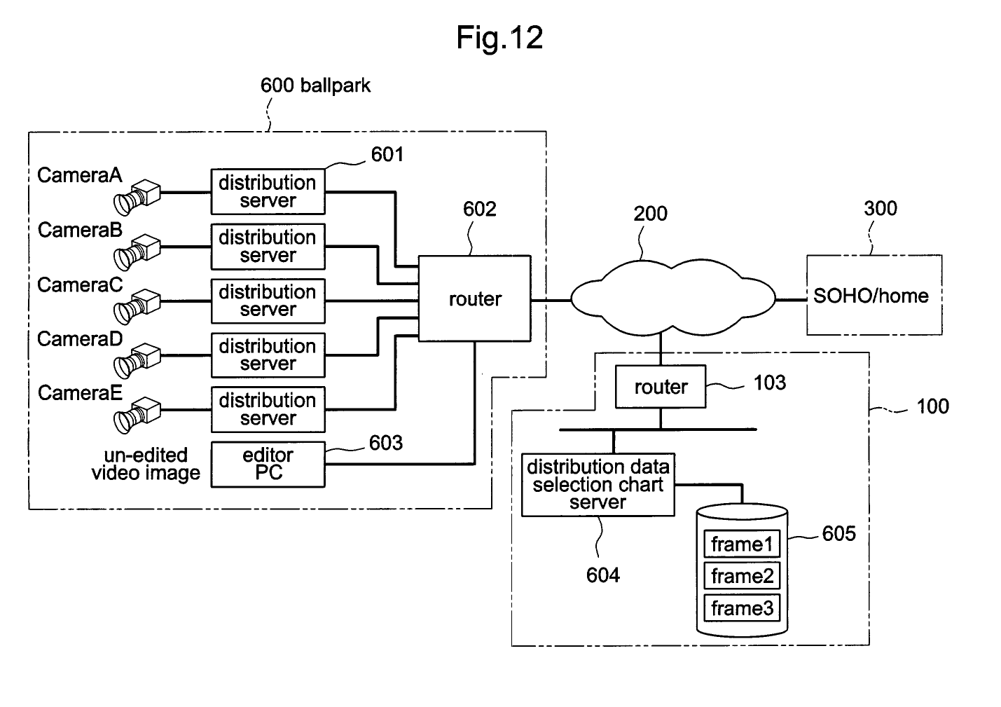

FIG. 12 illustrates a system configuration of a video distribution system according to the present embodiment. In FIG. 12, parts having the same numerical characters as in FIG. 1 represent the same functions as in FIG. 1. However, distribution data selection terminal having the same function as program selection terminal 305 of FIG. 1 has the same numerical character but named differently, so that the differences in the selection object are clearly illustrated. As shown in FIG. 12, TV cameras A-E are installed at ballpark 600 where a baseball live broadcasting is performed. These plurality of TV cameras A-E can capture images of the game content and status inside the ballpark from a plurality of angles. The video image signals output from TV cameras A-E are input in each corresponding distribution server 601. In this example, five distribution servers 601 are provided to correspond to five TV cameras A-E.

Distribution server 601 performs a multicast distribution of video signals provided from the corresponding TV camera, as one of the programs. In particular, at distribution server 601, video signals are converted into MPEG bit stream data and transmitted to Internet 200 via router 602 as an IP packet by attaching a multicast address. In this example, individual distribution server 601 has a multicast address pre-registered in advance to be used for the multicast distribution of the camera video images.

Also, editor PC 603 to be used by an editor is installed in ballpark 600. The editor PC 603 is connected to router 602, which makes it possible to communicate using HTTP. This editor PC 603 updates a predetermined frame of an EPG, which is later described.

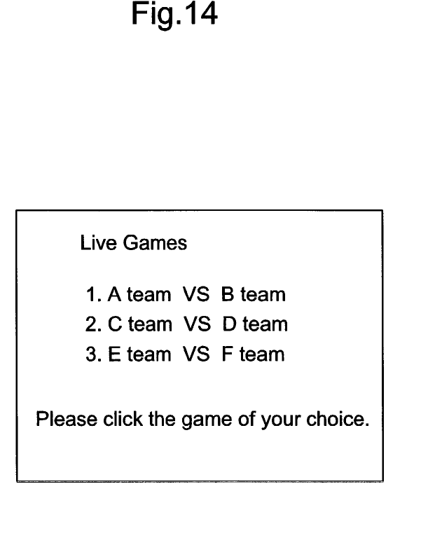

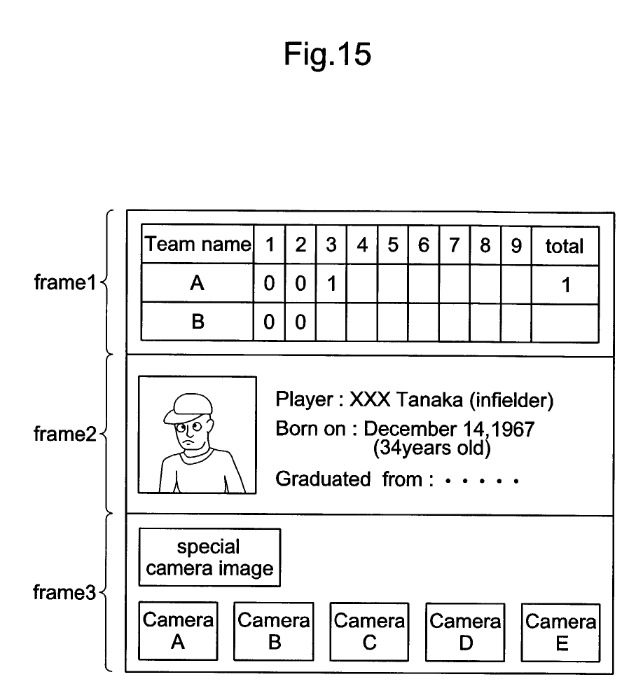

Distribution data selection chart server 604 is installed in data center/broadcast station 100. Distribution data selection chart server 604 is configured to be able to provide a homepage as shown in FIG. 14, and an EPG as shown in FIG. 15, to a browser using the HTTP. Data retainer 605 stores various files that configure the homepage and EPG.

FIG. 15 is used to illustrate in detail an EPG according to the second embodiment of the present invention. FIG. 15 illustrates an example configuration of the EPG for live broadcasting of a baseball game, showing an EPG screen displayed on distribution data selection terminal 305. This EPG includes frame 1 that displays a game score, frame 2 that displays profile of a player, and frame 3 that displays a program guide.

Frame 1 that displays the game score can be updated from editor PC 603 of ballpark 600, using the HTTP. Specifically, an editor that monitors the game in ballpark 600 uses editor PC 603, accesses distribution data selection chart server 604 using the HTTP, and transmits a file with an updated score to distribution data selection chart server 604, every time there is a change in the score. Upon receiving the file with the updated score from editor PC 603, distribution data selection chart server 604 updates frame 1 stored in data retainer 605 with the newly received file, in order to reflect updated scores at all times.

Frame 2 that displays profile of a player is provided with all players to be introduced with their profiles. Distribution data selection chart server 604 updates frame 2 with a profile of a different player at a predetermined time interval.

Frame 3 that displays a program, described with the HTML, displays icons corresponding to TV cameras A-E set in ballpark 600, each of which representing a program to be selected. Similar to the first embodiment, a source code (HTML source) of a different page is embedded in each program (camera icon A-E). Particularly, “http://hgw/ch.fee:1” is embedded in “TV camera A”, having the same meaning as described in the first embodiment. “fee:1” is a multicast address of a program that is distributed in the multicast method by distribution server 601. Similarly, source codes are embedded in other programs (TV cameras B-E).

In addition, special camera images in frame 3 are images that is displayed based on the video file transmitted from editor at ballpark 600 through editor PC 603. In other words, the editor can arbitrarily display video images of a program (TV camera) recommended by the editor on the EPG.

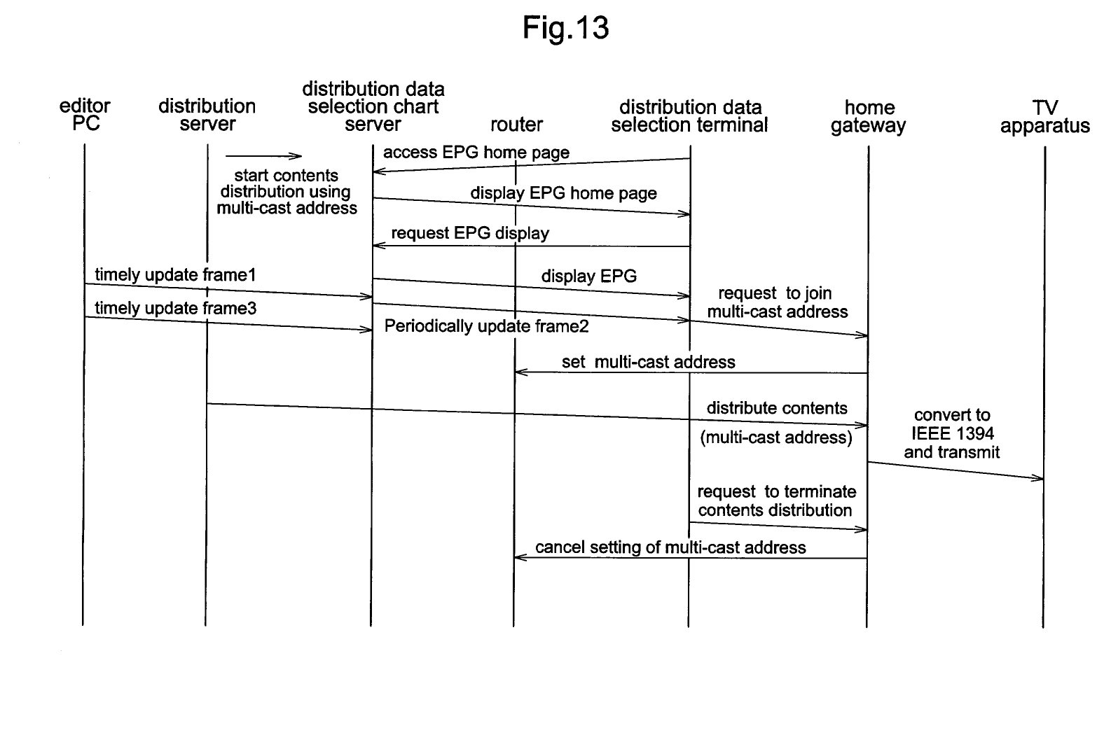

Next, FIG. 13 is a sequence chart illustrating the operation according to the second embodiment.

When distribution data selection terminal 305 accesses a homepage provided by distribution data selection chart server 604, distribution data selection chart server 604 transmits the homepage as illustrated in FIG. 14. FIG. 14 illustrates a display of games that are broadcasted live.

When a desired game to be distributed is clicked on the homepage screen from distribution data selection terminal 305, an EPG display request corresponding to the selected game is generated, and the EPG requested by distribution data selection chart server 604 is transmitted. FIG. 15 illustrates an example of an EPG displayed on distribution data selection terminal 305.

Distribution data selection chart server 604 transmits frame 2 of the EPG by periodically updating a frame with a different player profile. Accordingly, the EPG displayed on distribution data selection terminal 305 can rotate profiles of the players to be introduced.

The editor at ballpark 600 transmits an updated score to distribution data selection chart server 604 every time there is a change in the game. In this example, editor PC 603 and distribution data selection chart server 604 mutually communicates using the HTTP, and the editor at a distant ballpark 600 rewrites frame 1 of the EPG, using a CGI command. Accordingly, the EPG provided by distribution data selection chart server 604 can display the updated score.

Since the editor at ballpark 600 oversees the entire game without the limitation of camera images, the editor can determine which TV camera has the most interesting images. Therefore, the EPG displays images from the TV camera that capture the video images recommended by the editor, as a special camera. This is also done when the editor at a distant ballpark 600 rewrites the image file that displays video images of the special camera on the EPG, using the CGI command.

In addition, releasing the multicast address can be performed similarly to the first embodiment.

According to the second embodiment, video images from a plurality of TV cameras A-E setup in ballpark 600 are distributed as programs by the multicast method, so that user can just select a desired TV camera using distribution data selection terminal 305 to display the selected TV camera images on a TV apparatus at home or the like.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

This application is based on the Japanese Patent Application No. 2002-072158 filed on Mar. 15, 2002, entire content of which is expressly incorporated by reference herein.

What is claimed is:

1. An information distribution system comprising:
an address server that stores multicast addresses used for a distribution of contents;
a distribution server that distributes the contents, using the multicast addresses; and
a reception terminal that obtains the multicast addresses stored in said address server, and receives the contents from said distribution server, using the obtained multicast addresses.

2. The information distribution system according to claim 1, wherein said reception terminal sets up the obtained multicast addresses on a router of an IP network so that contents corresponding to the multicast addresses set up on the router can be received.

3. The information distribution system according to claim 1, wherein said address server stores each multicast address in association with each program title.

4. The information distribution system according to claim 1, wherein said reception terminal notifies said address server of an IP address of said reception terminal, using cookie information of said reception apparatus.

5. A program guide server comprising:
a memory configured to store a program guide which describes various contents distributed in a program guide format, and multicast addresses used for distributing each content; and
a transmitter configured to transmit a program guide including the multicast addresses to a requesting terminal, in response to a request from the requesting terminal accessing via the IP network.

6. The program guide server according to claim 5, wherein, when a terminal selects a desired set of contents, the program guide is programmed to make a request to a gateway that connects the terminal with the IP network, for a setup of the multicast address of the desired set of contents.

7. The program guide server according to claim 6, wherein, when the terminal selects a program termination button, the program guide is programmed to make a request to the gateway that connects the terminal with the IP network, for canceling the previously setup multicast address.

8. A gateway connected to a terminal at home, comprising:
a receiver that receives program guide data from a program guide server which stores the program guide data, the program guide data comprising multicast addresses and program titles, the multicast address being in association with the program title;
a transmitter that transmits the received program guide data to the terminal; and
a controller that sets up a router on an IP network so that the router is able to receive the multicast address when a request for reception of a content corresponding to the multicast address, obtained based on the program guide data from the terminal.

9. A method for distributing information, using address server which stores multicast address, utilized a distribution of contents, the method comprising:
obtaining multicast address of content which requests a distribution from address server; and
setting up multicast address to a router on an IP network, using the obtained multicast address, in order to receive contents distributed from a distribution server which stores contents and transmits said contents to the terminal

10. A program guide distribution method comprising:
retaining a program guide which displays various contents distributed via an IP network in a program guide format, and a multicast address used for distributing each set of contents;
analyzing a request from a terminal accessing via the IP network; and
transmitting a program guide including the multicast address to the requesting terminal, when the request is for the program guide.

11. A distribution data selection chart server comprising:
a memory configured to store the data selection chart that includes multicast addresses, which is used for distributing each individual video images captured by a plurality of TV cameras with different angles into each distribution data via an IP network
a transmitter that transmits the data selection chart and multicast addresses to a requesting terminal, in response to a request made by the terminal accessing via the IP network.
